(19) United States
(12) Patent Application Publication
(10) Pub. No.: US 2014/0218264 A1
(43) Pub. Date: Aug. 7, 2014

(54) ROTMAN LENS

(71) Applicants: FURUKAWA ELECTRIC CO., LTD, Tokyo (JP); Furukawa Automotive Systems Inc., Shiga (JP)

(72) Inventor: Takashi KAWATE, Tokyo (JP)

(73) Assignees: FURUKAWA ELECTRIC CO., LTD., Tokyo (JP); Furukawa Automotive Systems Inc., Shiga (JP)

(21) Appl. No.: 14/250,135

(22) Filed: Apr. 10, 2014

Related U.S. Application Data
(63) Continuation of application No. PCT/JP2013/052425, filed on Feb. 1, 2013.

(30) Foreign Application Priority Data
Mar. 26, 2012 (JP) 2012-069785

(51) Int. Cl. H01Q 15/02

(52) U.S. Cl. CPC H01Q 15/02
USPC 343/909

(57) ABSTRACT

A Rotman lens, having a ground plane 80 made up of a conductive member and a dielectric substrate 70 disposed on the ground plane 80, and disposed at a position facing the ground plane 80 sandwiching the dielectric substrate 70, including plural input ports 11 to 15 and plural output ports 41 to 47, in which waveguides 51 to 56 guiding a signal input to one input port to the plural output ports are disposed in the dielectric substrate 70 along a line connecting both ends of the plural output ports 41 to 47 and the one input port in an aspect in which the waveguides do not interfere with each other, reduces a loss thereof.

### RELATED APPLICATION

This application is a continuation of, and claims priority to, PCT Patent Application No. PCT/JP2013/052425, filed Feb. 1, 2013 and entitled “ROTMAN LENS”, which claims priority to Japanese Patent Application No. 2012-069785, filed Mar. 26, 2012. The entireties of the above-referenced applications are incorporated herein by reference.

### TECHNICAL FIELD

The present invention relates to a Rotman lens.

### BACKGROUND ART

In Patent Document 1, a Rotman lens including plural input ports and output ports is disclosed. In the Rotman lens as stated above, electric power is supplied into the Rotman lens when one input port is excited. The electric power in the Rotman lens is taken out from the output port, and supplied to an array antenna element. An excitation amplitude and an excitation phase of the array antenna element are determined depending on the input port to be excited, and a beam direction in a space is determined in accordance with the excitation phase of an array antenna.

### PRIOR ART DOCUMENT

### Patent Document

Patent Document 1: Japanese Patent Application Laid-open No. 2010-200316

### SUMMARY OF THE INVENTION

### Problem to be Solved by the Invention

Incidentally, in an art disclosed in Patent Document 1, there is a case when an excitation signal is transmitted to the other input port when one input port is excited, and there is a problem in which a loss occurs in such a case.

Accordingly, an object of the present invention is to provide a Rotman lens whose loss is small.

### Means for Solving the Problems

To solve the above-stated problem, the present invention is characterized in that: having a ground plane made up of a conductive member and a dielectric substrate disposed on the ground plane, and disposed at a position facing the ground plane sandwiching the dielectric substrate, including plural input ports and plural output ports, and in which waveguides guiding a signal input to one input port to the plural output ports are disposed along a line connecting both ends of the plural output ports and the one input port in the dielectric substrate in an aspect in which the waveguides do not interfere with each other.

According to the constitution as stated above, it is possible to obtain the Rotman lens whose loss is small.

Besides, another invention is characterized in that the waveguide is made up of one or plural conductive member(s) connecting the ground plane and the Rotman lens and disposed along the line connecting the both ends of the plural output ports and the one input port in addition to the above-stated invention.

According to the constitution as stated above, it is possible to reduce the loss because the signal input from the input port is able to be effectively guided to the output port.

Still another invention is characterized in that the conductive member is a through hole connecting the ground plane and the Rotman lens in addition to the above-stated invention.

According to the constitution as stated above, it is possible to easily form the waveguide, and therefore, it is possible to prevent increase of manufacturing cost.

Still another invention is characterized in that the input port includes a transmission line where a signal is input and a taper part having a taper shape connecting the transmission line and a main body part of the Rotman lens, and the waveguide is disposed along the line starting at an end part of a connection part between the taper part and the main body part of the Rotman lens in addition to the above-stated invention.

According to the constitution as stated above, it is possible to effectively guide the signal input from the input port to the output port by preventing leakage of the signal from the taper part.

Still another invention is characterized in that the plural input ports are each disposed while sandwiching a dummy input port which is matching terminated in addition to the above-stated invention.

According to the constitution as stated above, it is possible to improve isolation of the input ports with each other.

Yet another invention is characterized in that one or plural ground plane(s) and dielectric substrate(s) are laminated to be disposed at the ground plane side or the Rotman lens side, and the waveguide is made up of one or plural conductive member(s) being a conductive member connecting the plural ground planes and the Rotman lens, and disposed along the line connecting the both ends of the plural output ports and the one input port in addition to the above-stated invention.

According to the constitution as stated above, it is possible to reduce the loss because the signal input from the input port can be effectively guided to the output port even when the plural ground planes and dielectric substrates are included.

### Effect of the Invention

According to the present invention, it is possible to provide a Rotman lens whose loss is small.

### BRIEF DESCRIPTION OF DRAWINGS

FIG. 1 is a view illustrating a configuration example of a Rotman lens according to an embodiment of the present invention;

FIG. 2 is a sectional view illustrating a cross section of the Rotman lens illustrated in FIG. 1;

FIG. 3 is a view to explain dispositions of through holes constituting waveguides;

FIG. 4 is a view to explain the dispositions of the through holes constituting the waveguides;

FIG. 5 is a view to explain the dispositions of the through holes constituting the waveguides;

FIG. 6 is a view illustrating a configuration of a conventional Rotman lens;

FIG. 7 is a view comparing losses of the Rotman lenses illustrated in FIG. 1 and FIG. 6;

FIG. 8 is a view illustrating characteristics of the conventional Rotman lens illustrated in FIG. 6;

FIG. 9 is a view illustrating characteristics of the Rotman lens of the embodiment illustrated in FIG. 1;

FIG. 10 is a view illustrating another embodiment of the present invention; and

FIG. 11 is a view illustrating still another embodiment of the present invention.

### BEST MODE FOR CARRYING OUT THE INVENTION

Next, embodiments of the present invention are described.

### (A) Description of Configuration of Embodiment

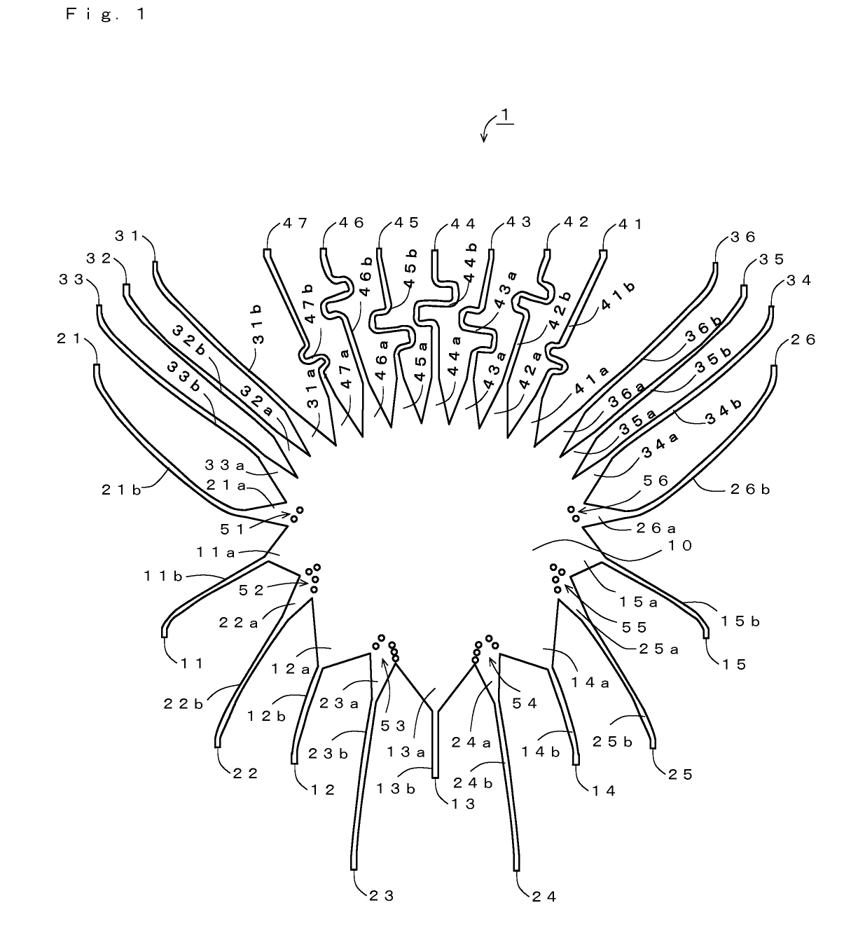

FIG. 1 is a view illustrating a configuration example of a Rotman lens according to an embodiment of the present invention. As illustrated in the drawing, a Rotman lens 1 includes a main body part 10 made up of a conductive plate material and having approximately a circular shape, input ports 11 to 15, output ports 41 to 47, and dummy ports 21, 22, 31 to 36.

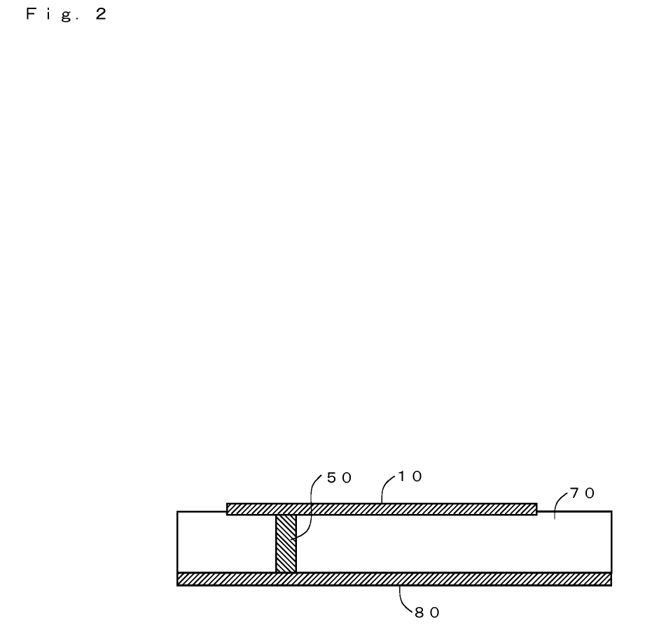

FIG. 2 is a sectional view illustrating a cross section of the Rotman lens 1. As illustrated in the drawing, the Rotman lens 1 is made up of a ground plane 80 constituted by a plate-shaped conductive member, a dielectric substrate 70 disposed on the ground plane 80, and a plate-shaped conductive member disposed to face the ground plane 80 sandwiching the dielectric substrate 70. Note that the main body part 10 and the ground plane 80 are connected by plural through holes 50 as described below. Besides, these through holes 50 constitute waveguides as described below.

Return to FIG. 1, the input ports 11 to 15 include taper parts 11a to 15a and transmission lines 11b to 15b. Here, each of the transmission lines 11b to 15b is made up of a conductive member such as a copper foil, electric power is applied to one end thereof to be excited, and the other end is connected to each of the taper parts 11a to 15a. Each of the taper parts 11a to 15a has a taper-shape, one end is connected to the other end of each of the transmission lines 11b to 15b, and the other end being an opening part is connected to the main body part 10.

The output ports 41 to 47 are disposed at approximately an opposite side of the input ports 11 to 15, and include taper parts 41a to 47a and transmission lines 41b to 47b. Here, each of the transmission lines 41b to 47b is made up of a conductive member such as a copper foil, radio waves are emitted from one end, and the other end is connected to each of the taper parts 41a to 47a. Each of the taper parts 41a to 47a has a taper-shape, one end is connected to the other end of each of the transmission lines 41b to 47b, and the other end being an opening part is connected to the main body part 10.

The dummy ports 21 to 26 are disposed at both sides of the input ports, and include taper parts 21a to 26a and transmission lines 21b to 26b. Here, each of the transmission lines 21b to 26b is made up of a conductive member such as a copper foil, one end is matching-terminated, and the other ends are respectively connected to the taper parts 21a to 26a. Each of the taper parts 21a to 26a has a taper-shape, one end is connected to the other end of each of the transmission lines 21b to 26b, and the other end being an opening part is connected to the main body part 10.

The dummy ports 31 to 33 are disposed between the output port 47 and the dummy port 21, and the dummy ports 34 to 36 are disposed between the output port 41 and the dummy port 26. The dummy ports 31 to 36 include taper parts 31a to 36a and transmission lines 31b to 36b. Here, the transmission lines 31b to 36b are each constituted by a conductive member such as a copper foil, one end is matching-terminated, and the other end is connected to each of the taper parts 31a to 36a. The taper parts 31a to 36a each have a taper-shape, each one end is connected to the other end of the lines 31b to 36b, and the other end being an opening part is connected to the main body part 10.

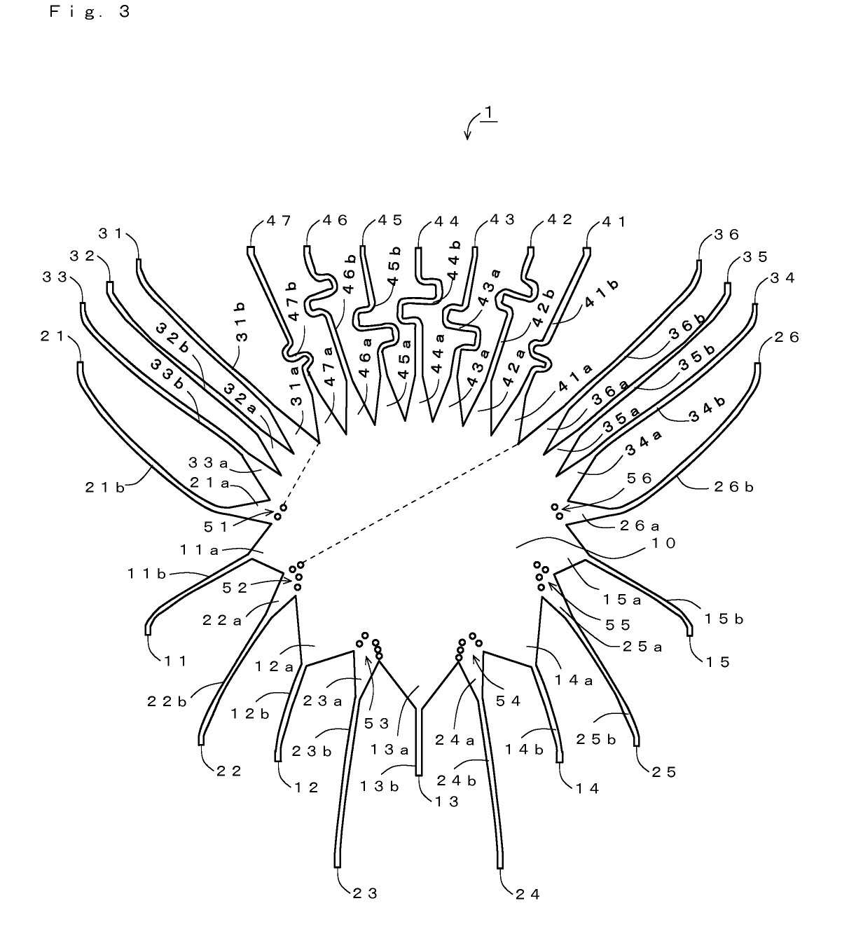

Besides, waveguides 51 to 56 made up of plural through holes 50 are formed in a vicinity of the opening parts of the taper parts 11a to 15a of the input ports 11 to 15. FIGS. 3 to 5 are views to explain configuration examples of the waveguides 51 to 56. FIG. 3 is a view to explain a configuration example of the waveguides 51, 52 disposed at the taper part 11a of the input port 11. As illustrated in FIG. 3, the waveguide 51 is made up by disposing two through holes along a dotted line connecting a left end of the opening part of the taper part 47a and an upper end of the opening part of the taper part 11a. Besides, an upper side of the waveguide 52 is made up by disposing two through holes along a dotted line connecting a right end of the opening part of the taper part 41a and a lower end of the opening part of the taper part 11a.

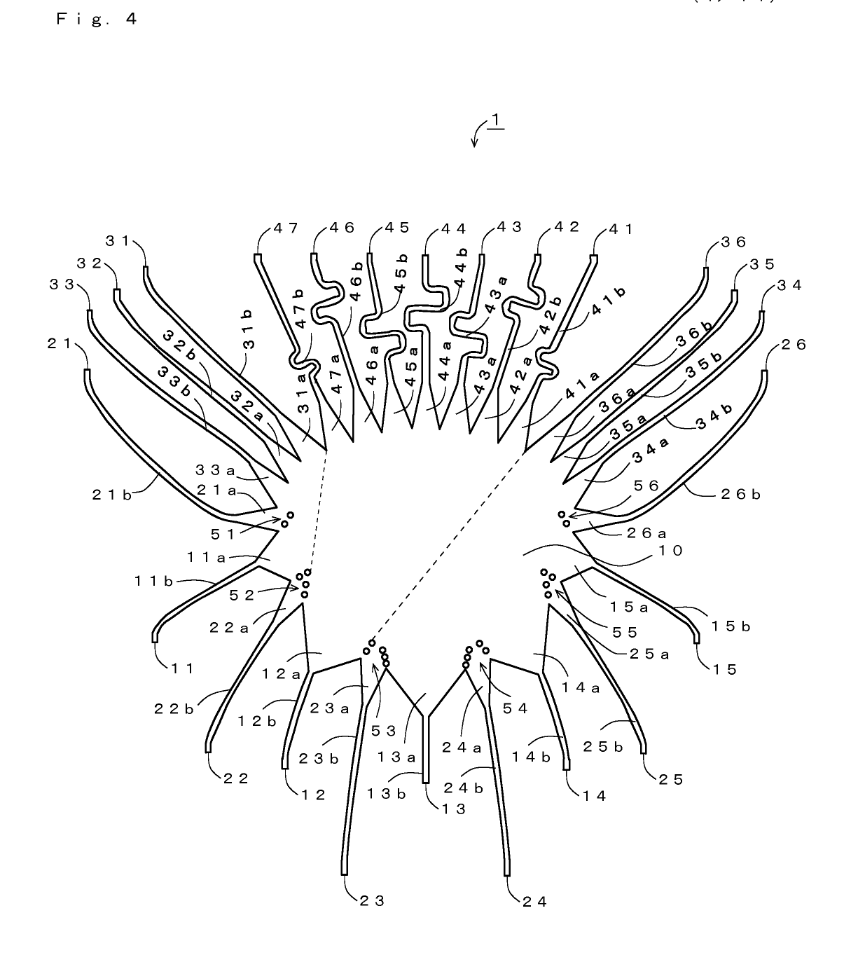

FIG. 4 is a view to explain the configuration example of the waveguides 52, 53 disposed at the taper part 12a of the input port 12. As illustrated in the drawing, a lower side of the waveguide 52 is made up by disposing three through holes along a dotted line connecting a left end of the opening part of the taper part 47a and an upper end of the opening part of the taper part 12a. Besides, a left side of the waveguide 53 is made up by disposing two through holes along a dotted line connecting a right end of the opening part of the taper part 41a and a lower end of the opening part of the taper part 12a.

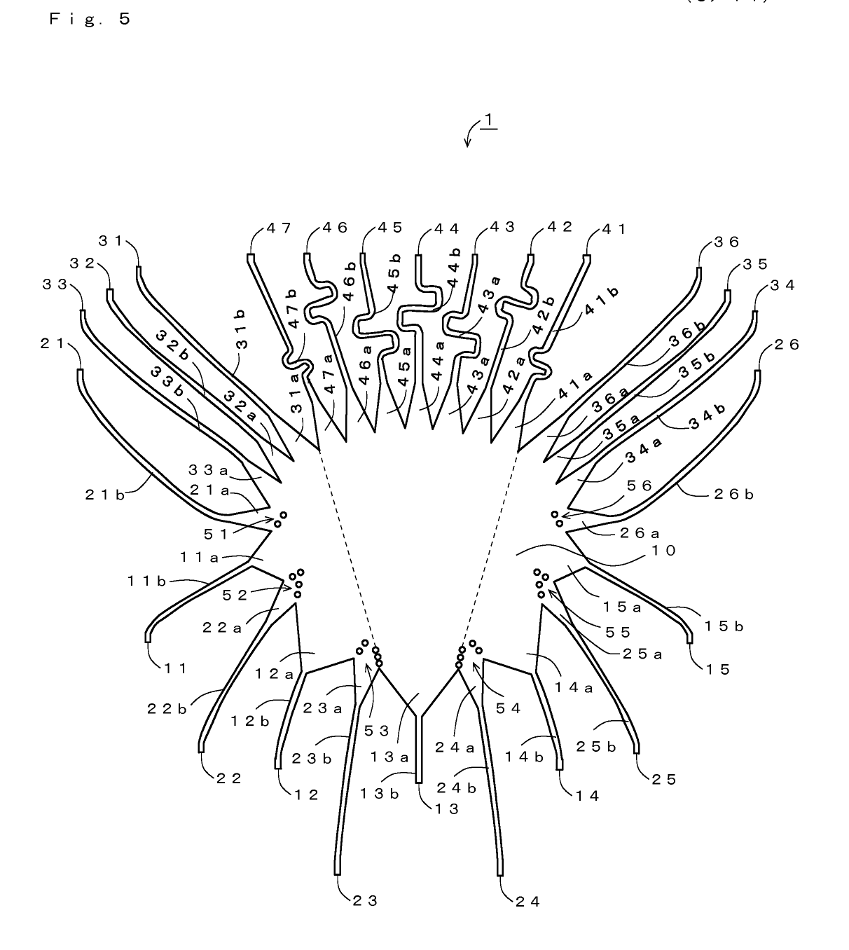

FIG. 5 is a view to explain the configuration example of the waveguides 53, 54 disposed at the taper part 13a of the input port 13. As illustrated in the drawing, a right side of the waveguide 53 is made up by disposing three through holes along a dotted line connecting a left end of the opening part of the taper part 47a and a left end of the opening part of the taper part 13a. Besides, a left side of the waveguide 54 is made up by disposing three through holes along a dotted line connecting a right end of the opening part of the taper part 41a and a right end of the opening part of the taper part 13a.

The plural through holes 50 constituting the waveguides 51 to 56 are set to have an interval so that a signal does not leak out from between adjacent through holes 50. As an example, when a signal wavelength is λ, the interval can be set at approximately λ/4. It goes without saying that the interval may be set at a value other than the above.

Note that the waveguides 55, 56 provided at the opening part of the taper parts 14a, 15a have configurations as same as the waveguides 51, 52, and therefore, descriptions thereof are not given.

### (B) Description of Operation of Embodiment

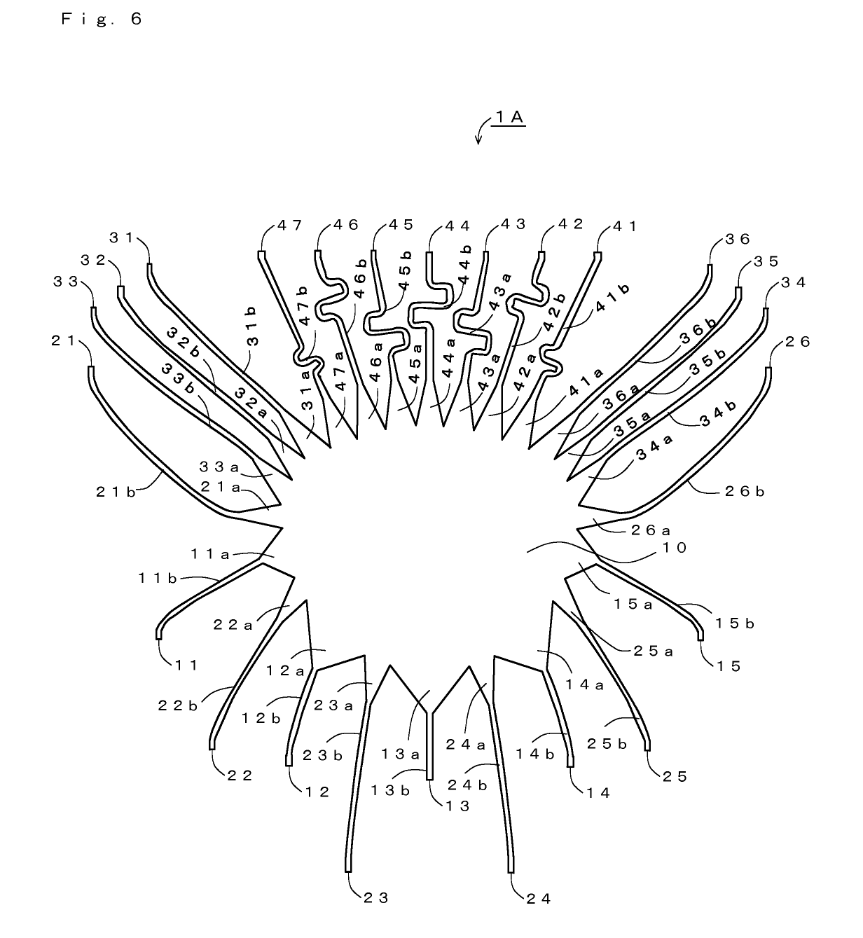

The Rotman lens 1 according to the embodiment of the present invention is different compared to a conventional Rotman lens 1A illustrated in FIG. 6 in a point of including the waveguides 51 to 56. In the Rotman lens 1 according to the present embodiment, a signal input to the transmission lines 11b to 15b is input to the main body part 10 of the Rotman lens 1 via the taper parts 11a to 15a. In the conventional Rotman lens 1A illustrated in FIG. 6, a signal input from any of the taper parts 11a to 15a is transmitted not only to the output ports 41 to 47 but also to the other input ports, and therefore, this causes a loss. More specifically, for example, a signal input from the input port 13 is not only transmitted to the output ports 41 to 47 but also a part thereof is transmitted to the input ports 11, 12, 14, 15, and therefore, this causes the loss.

On the other hand, in the present embodiment, when a signal is input to the transmission lines 11b to 15b, it is input to the main body part 10 of the Rotman lens 1 via the taper parts 11a to 15a. At this time, the plural through holes 50 are formed at both ends of the opening parts of the taper parts 11a to 15a. These through holes 50 are connected to the ground plane 80 as illustrate in FIG. 2, and therefore, they become ground potentials. When the through holes 50 being the ground potentials exist, a space shut out by the main body part 10, the through holes 50, and the ground plane 80 is formed, and therefore, this space functions as the waveguide. Accordingly, a travel direction of the signal emitted from the opening parts of the taper parts 11a to 15a is adjusted by the waveguides 51 to 56, and the signal is propagated toward the output ports 41 to 47. Almost all of the signal input from the input ports 11 to 15 is thereby propagated to the output ports 41 to 47, and therefore, it is possible to reduce the loss by reducing the signal propagated to the other input ports.

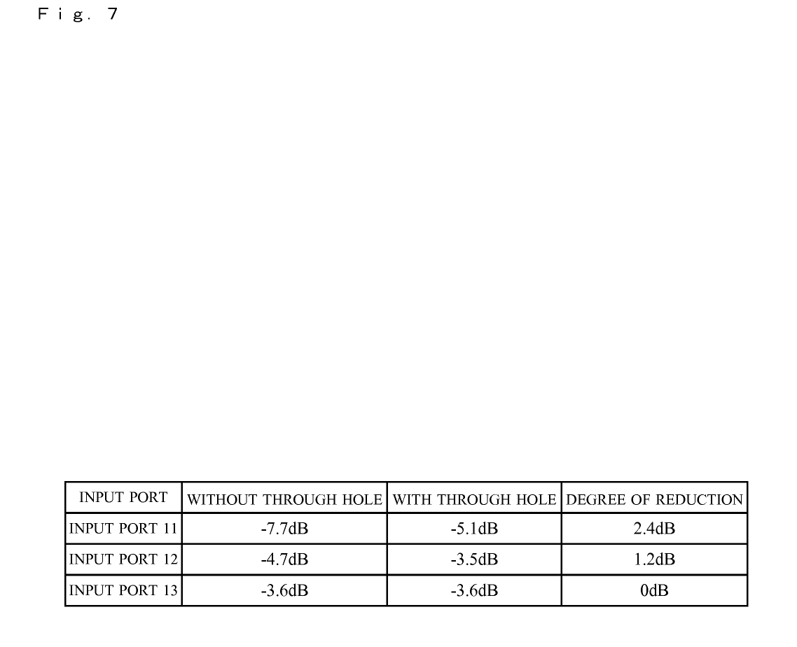

A table illustrated in FIG. 7 is a table comparing losses of the embodiment of the present invention illustrated in FIG. 1 and the conventional configuration illustrated in FIG. 6. More concretely, the table illustrated in FIG. 7 represents a loss between the input and output ports when a signal is input to the input ports 11 to 13, and the signal is observed at the output ports 41 to 47. Here, the loss represents a total sum of the signal leaked to be transmitted to ports other than the output ports 41 to 47 from the signal input from one input port. Namely, an uppermost level of the table illustrated in FIG. 7 represents that the losses of the configurations in FIG. 6 and FIG. 1 when the signal is input to the input port 11 are respectively −7.7 dB and −5.1 dB, and it can be seen that the embodiment of the present invention illustrated in FIG. 1 reduces the loss for 2.4 dB. Besides, a second level represents that the losses of the configurations in FIG. 6 and FIG. 1 when the signal is input to the input port 12 are respectively −4.7 dB and −3.5 dB, and it can be seen that the embodiment of the present invention illustrated in FIG. 1 reduces the loss for 1.2 dB. Besides, a third level represents that the losses of the configurations in FIG. 6 and FIG. 1 when the signal is input to the input port 13 are respectively −3.6 dB and −3.6 dB, and it can be seen that a reduction effect of loss does not appear in case of the input port 13. Note that in the configuration of the waveguides 53, 54 illustrated in FIG. 1, the reduction effect of loss does not appear in case of the input port 13, but it is known from experiments of the inventors that the reduction effect can be obtained also as for the input port 13 by adjusting the configuration of the waveguides 53, 54.

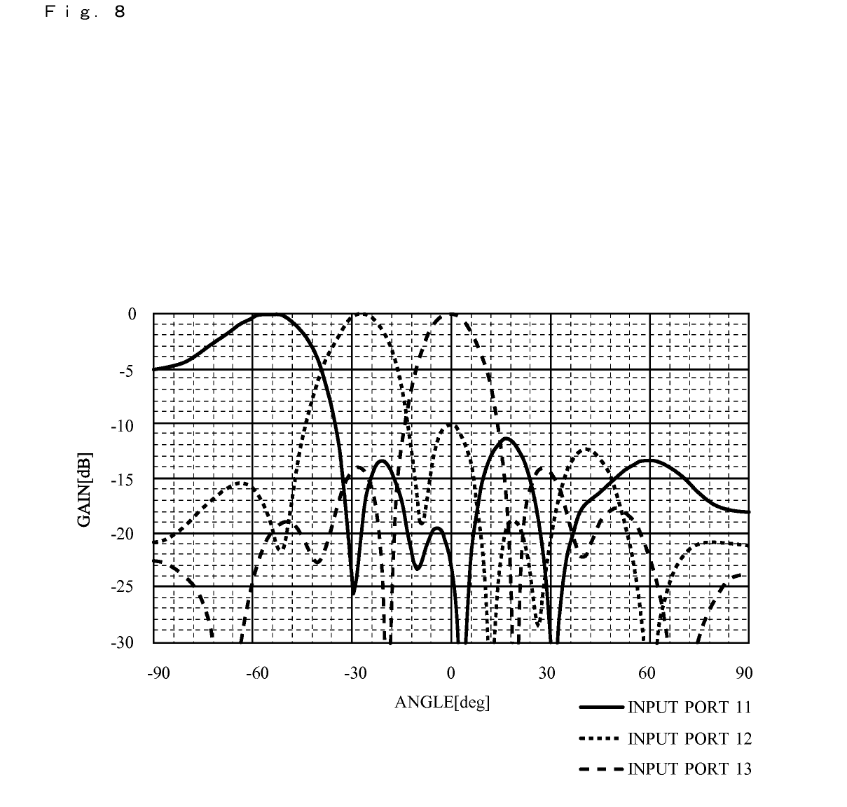

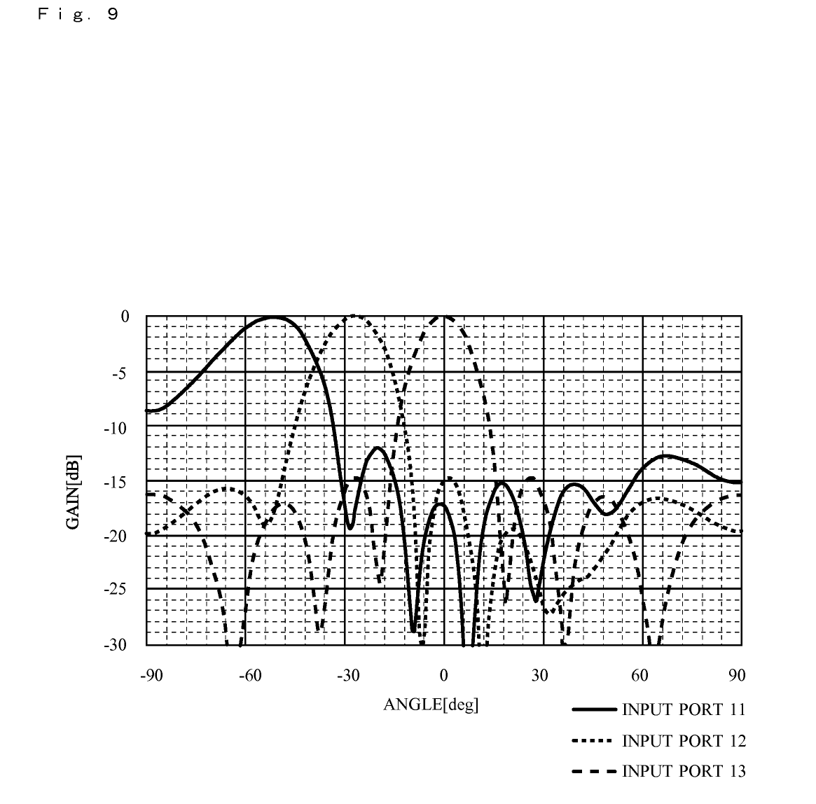

FIG. 8 is a view illustrating an array factor of the conventional configuration illustrated in FIG. 6, and FIG. 9 is a view illustrating an array factor of the embodiment illustrated in FIG. 1. Namely, it is a view illustrating a calculation value of an ideal emission pattern when it is assumed that an ideal point source of wave, namely, an antenna isotropically emitting radio waves is provided at each output port. An amplitude ratio and a phase ratio of the radio waves emitted from each antenna are determined by an amplitude ratio and a phase ratio of the radio waves output to each output port. Note that a horizontal axis of each of these views represents an angle (deg), and a vertical axis represents a gain (dB). Besides, a solid line represents the array factor of the input port 11, a short dotted line represents the array factor of the input port 12, and a long dotted line represents an array factor of the input port 13. Note that each view is represented by being normalized based on a maximum gain. There is no change in a direction of a main beam whose gain is the maximum in each input port from a comparison between these FIGS. 8 and 9, and they are approximately “0” (zero) degree, 30 degrees, 60 degrees. On the other hand, as for a side lobe other than the main beam, the gain of the embodiment is smaller, and it can be seen that characteristics are improved.

As it is described hereinabove, according to the embodiment of the present invention, it becomes possible to improve directivity and reduce the loss without affecting on the characteristics of the main beam by providing the waveguides 51 to 56.

Besides, in the above-stated embodiment, it is possible to secure the directivity by adjusting shapes of the waveguides 51 to 56 even when there is a case when the directivity cannot be enough secured because shapes of the taper parts 11a to 15a cannot be set to be desired shapes and sizes caused by design restrictions.

Besides, in the above-stated embodiment, the waveguides 51 to 56 are made up of the through holes, and therefore, it is possible to reduce the loss without complicating a manufacturing process.

### (C) Description of Modified Embodiment

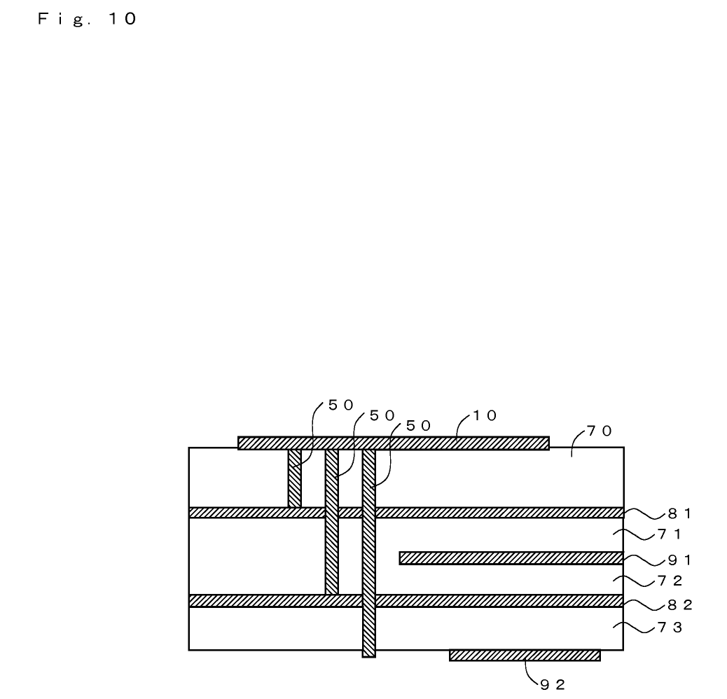

The above-stated embodiment is an example, and it goes without saying that the present invention is not limited to the above-stated cases. For example, in the above-stated embodiment, the main body part 10, the dielectric substrate 70, and the ground plane 80 are included as illustrated in FIG. 2, but for example, plural ground planes and dielectric substrates may be included as illustrated in FIG. 10. In an embodiment illustrated in FIG. 10, a dielectric substrate 71, an RF substrate 91, a dielectric substrate 72, a ground plane 82, a dielectric substrate 73, and an RF substrate (or an antenna substrate) 92 are laminated at a lower side of a ground plane 81 (a lower side in FIG. 10). Besides, as for the plural through holes 50, a part thereof is connected to the ground plane 81, another part thereof is connected to the ground plane 81 and the ground plane 82, still another part thereof is connected to the ground plane 81 and the ground plane 82 and penetrates all of the substrates. As stated above, the through holes penetrate the plural substrates and are connected to the plural ground planes, and thereby, it is possible to prevent that a signal leaks to a lower layer than the ground plane 81. Note that in FIG. 10, the respective through holes 50 are connected to the ground planes 81, 82 in different aspects, but they may be connected to the ground planes 81, 82 in the same aspect. Specifically, all of the through holes 50 are connected only to the ground plane 81, both of the ground planes 81, 82, or both of the ground planes 81, 82 and penetrate all of the substrates.

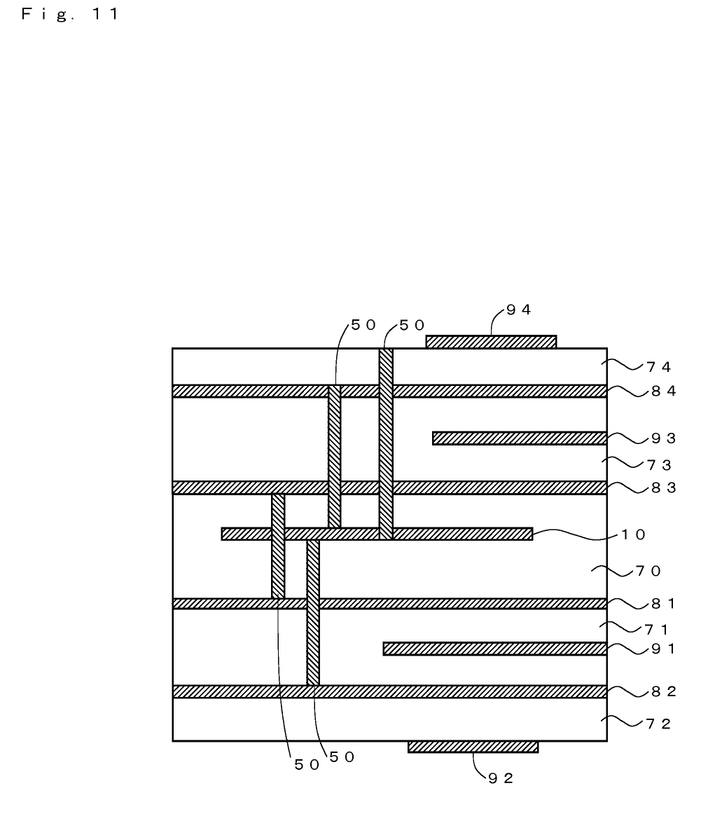

In an example in FIG. 11, the main body part 10 is disposed at a center, and the dielectric substrate 70 is disposed to sandwich the main body part 10. The ground plane 81 is disposed at a lower side of the dielectric substrate 70 (a lower side in FIG. 11), and the dielectric substrate 71, the RF substrate 91, the ground plane 82, the dielectric substrate 72, and the RF substrate (or the antenna substrate) 92 are disposed under the ground plane 81. Besides, a ground plane 83 is disposed at an upper side of the dielectric substrate 70 (an upper side in FIG. 11), and the dielectric substrate 73, an RF substrate 93, a ground plane 84, a dielectric substrate 74, and an RF substrate (or an antenna substrate) 94 are disposed on the ground plane 83. Besides, a part of the plural through holes 50 is connected to the ground planes 81, 83, another part is connected to the ground planes 81, 82, still another part is connected to the ground planes 83, 84, and yet another part is connected to the ground planes 83, 84 and penetrate all of the plural substrates at the upper side. As stated above, the through holes 50 penetrate the plural substrates and are connected to the plural ground planes, and thereby, it is possible to prevent that the signal leaks to lower layers than the ground plane 81 and upper layers than the ground plane 83. Note that in FIG. 11, the respective through holes 50 are connected to the ground planes 81 to 84 in different aspects, but they may be connected to the ground planes 81 to 84 in the same aspect as same as the case in FIG. 10.

Besides, the through holes 50 are used as the waveguides 51 to 56 in the above-stated embodiments, but a structure other than the through holes 50 may be used. For example, the waveguide may be constituted by one or plural pieces of conductor plate(s) connecting the main body part 10 and the ground plane instead of the through holes 50. Besides, the waveguides 51 to 56 are disposed on the dotted lines as illustrated in FIG. 3 to FIG. 5, but they may be disposed not on the dotted lines but at positions a little deviated from the dotted lines. Note that the waveguides 51 to 56 are to be disposed so that they do not interfere with each other as an aspect of the disposition of the waveguides 51 to 56. Specifically, the waveguides are to be disposed such that a signal emitted from a certain waveguide is not intercepted by the other waveguides.

Besides, in the above-stated embodiments, the waveguides 51 to 56 are provided at the both ends of the taper parts 11a to 15a of all of the input ports 11 to 15, but the waveguides may be provided only at a part of the input ports. Besides, it is not necessary to provide the waveguides at the both ends of the taper parts, but they may be provided only at one side.

Besides, in the above-stated embodiments, the taper parts 11a to 15a each have a linear shape, but they may each have a curved shape.

Besides, a configuration of the waveguides 51 to 56 illustrated in FIG. 1 is an example, and they may have the shapes other than the above. Specifically, it is possible to change the number and the disposing position of the through holes 50 in accordance with required characteristics.

Besides, in the above-stated embodiments, the dummy ports 21 to 26, 31 to 36 are disposed, but the dummy ports as stated above are not necessarily to be disposed. Further, the dummy ports 21 to 26 are disposed one by one between a pair of input ports, but two or more dummy ports may be disposed.

### EXPLANATION OF REFERENCE SIGNS

1 Rotman lens

10 main body part

11 to 15 input port

11a to 15a taper part

11b to 15b transmission line

21 to 26 dummy port

31 to 36 dummy port

41 to 47 output port

41a to 47a taper part

41b to 47b transmission line

1. A Rotman lens having: a ground plane made up of a conductive member; and a dielectric substrate disposed on the ground plane, and disposed at a position facing the ground plane sandwiching the dielectric substrate, the Rotman lens comprising:
plural input ports and plural output ports, and
wherein waveguides guiding a signal input to one input port to the plural output ports are disposed in the dielectric substrate along a line connecting both ends of the plural output ports and the one input port in an aspect in which the waveguides do not interfere with each other.

2. The Rotman lens according to claim 1,
wherein the waveguide is made up of one or plural conductive is member(s) connecting the ground plane and the Rotman lens and disposed along the line connecting the both ends of the plural output ports and the one input port.

3. The Rotman lens according to claim 1,
wherein the conductive member is a through hole connecting the ground plane and the Rotman lens.

4. The Rotman lens according to claim 2,
wherein the conductive member is a through hole connecting the ground plane and the Rotman lens.

5. The Rotman lens according to claim 1,
wherein the input port includes a transmission line where a signal is input, and a taper part connecting the transmission line and a main body part of the Rotman lens and having a taper shape, and the waveguide is disposed along the line starting from an end part of a connection part between the taper part and the main body part of the Rotman lens.

6. The Rotman lens according to claim 2,
wherein the input port includes a transmission line where a signal is input, and a taper part connecting the transmission line and a main body part of the Rotman lens and having a taper shape, and the waveguide is disposed along the line starting from an end part of a connection part between the taper part and the main body part of the Rotman lens.

7. The Rotman lens according to claim 3,
wherein the input port includes a transmission line where a signal is input, and a taper part connecting the transmission line and a main body part of the Rotman lens and having a taper shape, and the waveguide is disposed along the line starting from an end part of a connection part between the taper part and the main body part of the Rotman lens.

8. The Rotman lens according to claim 4,
wherein the input port includes a transmission line where a signal is input, and a taper part connecting the transmission line and a main body part of the Rotman lens and having a taper shape, and the waveguide is disposed along the line starting from an end part of a connection part between the taper part and the main body part of the Rotman lens.

9. The Rotman lens according to claim 1,
wherein the plural input ports are each disposed sandwiching a matching-terminated dummy input port.

10. The Rotman lens according to claim 2,
wherein the plural input ports are each disposed sandwiching a matching-terminated dummy input port.

11. The Rotman lens according to claim 3,
wherein the plural input ports are each disposed sandwiching a matching-terminated dummy input port.

12. The Rotman lens according to claim 4,
wherein the plural input ports are each disposed sandwiching a matching-terminated dummy input port.

13. The Rotman lens according to claim 5,
wherein the plural input ports are each disposed sandwiching a matching-terminated dummy input port.

14. The Rotman lens according to claim 1,
wherein one or plural ground plane(s) and dielectric substrate(s) are laminated to be disposed at the ground plane side or the Rotman lens side,
the waveguide is the conductive member connecting the plural ground planes and the Rotman lens, and is made up of one or plural conductive member(s) disposed along the line connecting the both ends of the plural output ports and the one input port.

15. The Rotman lens according to claim 2,
wherein one or plural ground plane(s) and dielectric substrate(s) are laminated to be disposed at the ground plane side or the Rotman lens side,
the waveguide is the conductive member connecting the plural ground planes and the Rotman lens, and is made up of one or plural conductive member(s) disposed along the line connecting the both ends of the plural output ports and the one input port.

16. The Rotman lens according to claim 3,
wherein one or plural ground plane(s) and dielectric substrate(s) are laminated to be disposed at the ground plane side or the Rotman lens side,
the waveguide is the conductive member connecting the plural ground planes and the Rotman lens, and is made up of one or plural conductive member(s) disposed along the line connecting the both ends of the plural output ports and the one input port.

17. The Rotman lens according to claim 4,
wherein one or plural ground plane(s) and dielectric substrate(s) are laminated to be disposed at the ground plane side or the Rotman lens side,
the waveguide is the conductive member connecting the plural ground planes and the Rotman lens, and is made up of one or plural conductive member(s) disposed along the line connecting the both ends of the plural output ports and the one input port.

18. The Rotman lens according to claim 5,
wherein one or plural ground plane(s) and dielectric substrate(s) are laminated to be disposed at the ground plane side or the Rotman lens side,
the waveguide is the conductive member connecting the plural ground planes and the Rotman lens, and is made up of one or plural conductive member(s) disposed along the line connecting the both ends of the plural output ports and the one input port.

19. The Rotman lens according to claim 9,
wherein one or plural ground plane(s) and dielectric substrate(s) are laminated to be disposed at the ground plane side or the Rotman lens side,
the waveguide is the conductive member connecting the plural ground planes and the Rotman lens, and is made up of one or plural conductive member(s) disposed along the line connecting the both ends of the plural output ports and the one input port.

20. The Rotman lens according to claim 10,
wherein one or plural ground plane(s) and dielectric substrate(s) are laminated to be disposed at the ground plane side or the Rotman lens side,
the waveguide is the conductive member connecting the plural ground planes and the Rotman lens, and is made up of one or plural conductive member(s) disposed along the line connecting the both ends of the plural output ports and the one input port.
